(19) United States
(12) Patent Application Publication
(10) Pub. No.: US 2026/0298776 A1
(43) Pub. Date: Oct. 1, 2026

(54) SAMPLE ASPIRATOR AND SAMPLE EXAMINING APPARATUS INCLUDING THE SAME

(71) Applicant: ALIGNED GENETICS, INC., Anyang-si (KR)

(72) Inventors: Neoncheol JUNG, Anyang-si (KR); Ghun KOH, Anyang-si (KR)

(21) Appl. No.: 19/577,153

(22) Filed: Mar. 24, 2026

(30) Foreign Application Priority Data
Mar. 25, 2025 (KR) 10-2025-0038146

(51) Int. Cl. G01N 1/14

(52) U.S. Cl. CPC G01N 1/14; G01N 2001/1418

(57) ABSTRACT

A sample aspirator may include a main body having a flow channel to allow a sample to flow; a sample suction button configured to be compressed when pressed by a user and to return to an initial shape when the pressing is released. The sample aspirator ma also include a pressure adjustment hole configured to equalize an air pressure in the flow channel with an atmospheric pressure when the pressing is released. The sample suction button may be configured to provide, to the flow channel, a sample suction pressure for moving the sample when the pressing is released.

### CROSS REFERENCE TO RELATED APPLICATIONS

This application claims priority to Korean patent application No. 10-2025-0038146 filed on Mar. 25, 2025, which is incorporated herein by reference in its entirety.

### BACKGROUND

### Technical Field

The present disclosure relates to a sample aspirator and a sample examining apparatus including the sample aspirator.

### Description of Related Technology

Generally, a wide variety of technologies are being used to analyze particles present in a liquid. Representative technologies for calculating an exact number and concentration of blood cells present in blood include a hemocytometer and an optical microscope.

Since the hemocytometer has a fixed height in a space into which a sample is injected, when the number of particles present in a predefined region inside the hemocytometer into which blood is injected is measured through an optical microscope, an exact concentration of particles in the predefined region of the hemocytometer may be calculated.

### SUMMARY

Embodiments of the present disclosure provide a sample aspirator for analyzing quantitative and qualitative information of particles present in a sample, and a sample examining apparatus including the sample aspirator.

Furthermore, embodiments of the present disclosure provide a sample aspirator for injecting a sample in a constant amount upon injection of the sample by an external force, and a sample examining apparatus including the sample aspirator.

In accordance with a first embodiment of the present disclosure, there is provided a sample aspirator including: a main body including a flow channel to allow a sample to flow; a sample suction button configured to be compressed when pressed by a user and to return to an initial shape when the pressing is released; and a pressure adjustment hole configured to equalize an air pressure in the flow channel with an atmospheric pressure when the pressing is released, wherein the sample suction button is configured to provide, to the flow channel, a sample suction pressure for moving the sample when the pressing is released.

Further, the main body may include: a first plate; a second plate; an injection port through which the sample is injected into the flow channel; and a spacer disposed between the first plate and the second plate and providing the flow channel.

Further, the sample suction button may include an air accommodating portion configured to be in communication with the flow channel and to accommodate air introduced through the pressure adjustment hole.

Further, the sample aspirator may further include: a haptic portion providing the user with a tactile sense of the sample suction button being pressed when the sample suction button is pressed by the user.

Further, the spacer may have a thickness of 20 to 1000 micrometers.

Further, adhesive may be applied to both surfaces of the spacer so that the spacer is bonded to the first plate and the second plate.

Further, a staining solution may be applied to a portion of the flow channel formed by the first plate and the second plate to allow particles in the sample to be identified.

Further, the haptic portion may include: a haptic support configured to support the sample suction button when the sample suction button is pressed by the user; and a plurality of haptic legs extending from an edge of the haptic support and having end portions supported on the main body.

Further, a haptic hole communicating with the pressure adjustment hole and the flow channel may be formed at a center of the haptic support.

In accordance with a second embodiment of the present disclosure, there is provided a sample examining apparatus including: a sample aspirator; and a holder configured to receive the sample aspirator to prevent contamination by a residual sample of the sample aspirator, wherein the sample aspirator includes: a main body including a flow channel to allow a sample to flow; a sample suction button configured to be compressed when pressed by a user and to return to an initial shape when the pressing is released; and a pressure adjustment hole configured to equalize an air pressure in the flow channel with an atmospheric pressure when the pressing is released, wherein the sample suction button is configured to provide, to the flow channel, a sample suction pressure for moving the sample when the pressing is released.

Further, the holder may be configured to be mounted to an optical device.

According to embodiments of the present disclosure, providing a disposable chamber having a fixed height for quantitative and qualitative analysis of particles present in a minute amount of sample enables an exact concentration calculation of the particles in the sample.

Furthermore, according to an embodiment of the present disclosure, staining is performed simultaneously with the injection of the sample, achieving staining simply by injecting the sample even without separately staining the sample from the outside.

Furthermore, according to an embodiment of the present disclosure, when particles present in a minute amount of sample are injected into the flow channel, the particles are uniformly distributed without occurrence of distortion in flow or concentration of the sample.

Furthermore, according to an embodiment of the present disclosure, when a minute amount of sample is injected, no deviation occurs among individuals performing the injection, allowing particles present in the minute amount of sample to be more accurately measured.

### BRIEF DESCRIPTION OF THE DRAWINGS

FIG. 1 is an assembled perspective view illustrating a sample examining apparatus according to an embodiment of the present disclosure.

FIG. 2 is an exploded perspective view viewed from above, illustrating a sample examining apparatus according to the embodiment of the present disclosure.

FIG. 3 is an exploded perspective view viewed from above, illustrating a sample aspirator according to the embodiment of the present disclosure.

FIG. 4 is an exploded perspective view viewed from below, illustrating the sample aspirator according to the embodiment of the present disclosure.

FIG. 5 is a cross-sectional view illustrating a cross-section taken along line V-V of FIG. 2.

FIG. 6 is a perspective view viewed from below, illustrating a holder of the sample examining apparatus according to the embodiment of the present disclosure.

FIG. 7 is a state diagram illustrating a state when a sample suction button is pressurized by a user.

### DETAILED DESCRIPTION

In the case of a semi-permanently manufactured hemocytometer, analyzing a plurality of samples requires a process of separating the hemocytometer from a cover glass and washing the hemocytometer after analyzing the sample in the hemocytometer, and accordingly, a disposable chamber slide has been proposed in various forms. Furthermore, a capillary force or an external force such as a piston may be used to inject the sample.

However, when a capillary force is used to inject a sample, a sufficiently small gap needs to be formed to generate a capillary phenomenon, and a surface on which the sample is transported needs to be maintained hydrophilic. Furthermore, when an external force such as a piston is used to inject the sample, negative pressure generated by the external force of the piston continuously flows the sample, making it difficult to precisely observe the sample.

Hereinafter, specific embodiments for implementing a spirit of the present disclosure will be described in detail with reference to the drawings.

In describing the present disclosure, detailed descriptions of known configurations or functions may be omitted to clarify the present disclosure.

When an element is referred to as being ‘supplied’ to, or ‘transferred’ to another element, it should be understood that the element may be directly supplied to, or transferred to another element, but that other elements may exist in the middle.

The terms used in the present disclosure are only used for describing specific embodiments, and are not intended to limit the present disclosure. Singular expressions include plural expressions unless the context clearly indicates otherwise.

Further, in the present disclosure, it is to be noted that expressions, such as the upper side and the lower side, are described based on the illustration of drawings, but may be modified if directions of corresponding objects are changed. For the same reasons, some components are exaggerated, omitted, or schematically illustrated in the accompanying drawings, and the size of each component does not fully reflect the actual size.

Terms including ordinal numbers, such as first and second, may be used for describing various elements, but the corresponding elements are not limited by these terms. These terms are only used for the purpose of distinguishing one element from another element.

In the present specification, it is to be understood that the terms such as “including” are intended to indicate the existence of the certain features, areas, integers, steps, actions, elements, combinations, and/or groups thereof disclosed in the specification, and are not intended to preclude the possibility that one or more other certain features, areas, integers, steps, actions, elements, combinations, and/or groups thereof may exist or may be added.

Hereinafter, a sample examining apparatus according to the present disclosure will be described in detail.

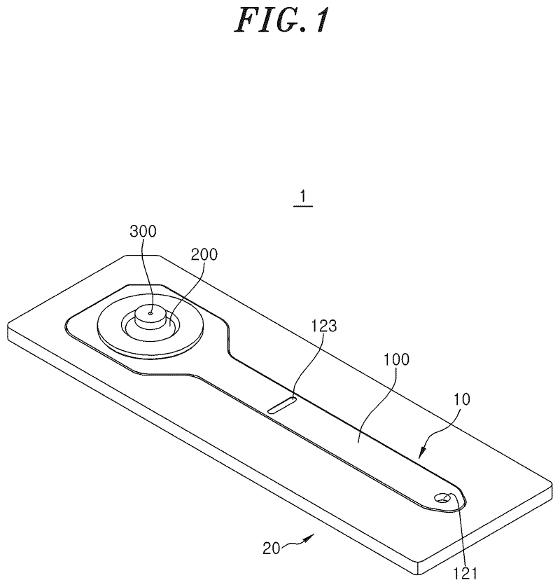

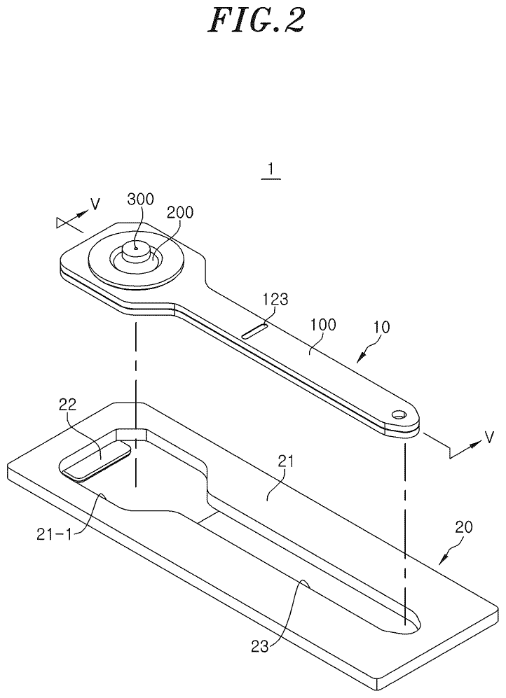

Referring to FIGS. 1 and 2, a sample examining apparatus 1 according to an embodiment of the present disclosure may be used to analyze quantitative and qualitative information of particles present in a sample. The sample examining apparatus 1 may include a sample aspirator 10 and a holder 20.

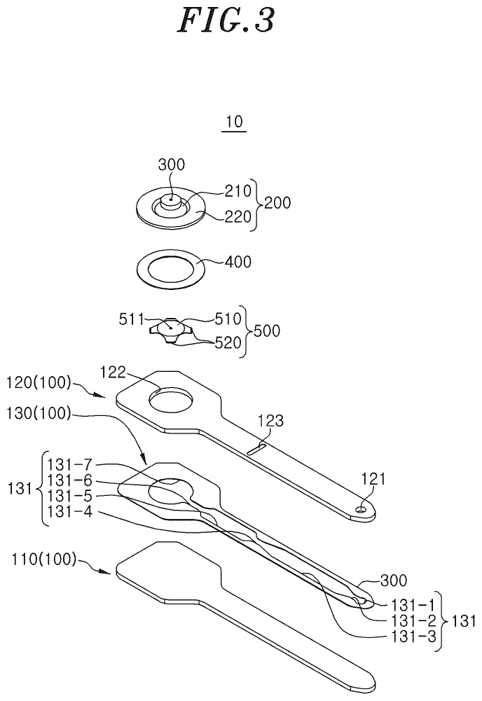

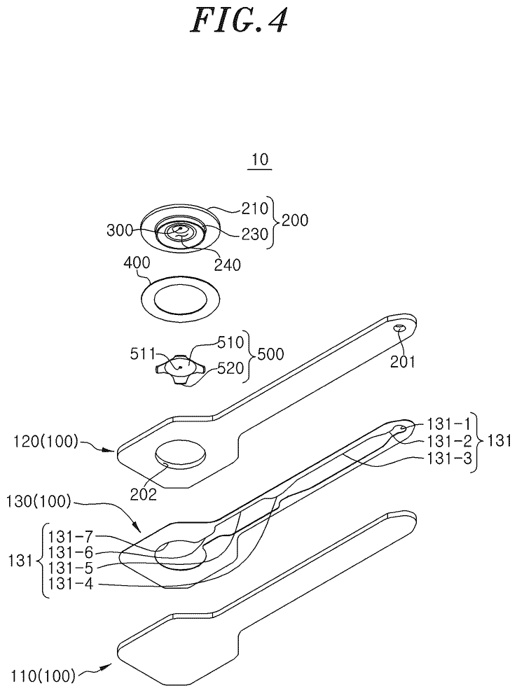

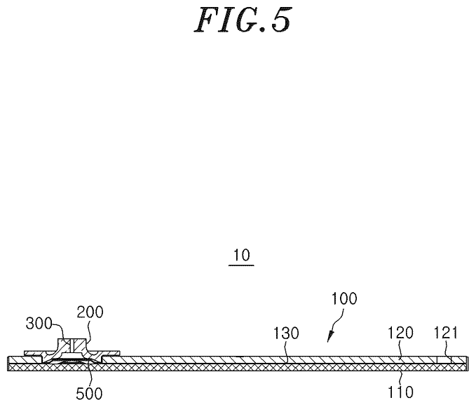

Referring to FIGS. 3, 4, and 5, the sample aspirator 10 may uniformly distribute particles without occurrence of distortion in flow or concentration of the sample when the sample is injected. The sample aspirator 10 may include a main body 100, a sample suction button 200, a pressure adjustment hole 300, a fixing ring 400, and a haptic portion 500.

The main body 100 may provide a flow channel 131 to allow the sample to flow. The sample may be injected into the flow channel 131, and may flow and stop by an action of the sample suction button 200 and the pressure adjustment hole 300. The main body 100 may include a first plate 110, a second plate 120, and a spacer 130. In the present embodiment, the main body 100 includes the first plate 110, the second plate 120, and the spacer 130, but the present disclosure is not limited thereto, and the main body 100 may be provided as a single component having the flow channel 131.

The first plate 110 may provide a lower surface of the flow channel 131 through which the sample may move when the sample is injected into the sample aspirator 10. A staining solution may be applied to an upper surface of the first plate 110. The staining solution may be a dye capable of dyeing the particles so that the particles in the sample become identifiable. When the sample is injected through an injection port 121 in a state where the staining solution is applied to the upper surface of the first plate 110, the sample may mix with the staining solution while flowing on the upper surface of the first plate 110 to which the staining solution is applied, and the particles in the sample may become identifiable by the staining solution.

The second plate 120 may provide an upper surface of the flow channel 131 through which the sample may move when the sample is injected into the sample examining apparatus 1. The second plate 120 may be disposed to be spaced apart from an upper side of the first plate 110. An upper surface of the spacer 130 may be disposed to contact a lower side of the second plate 120. The injection port 121 and a through-hole 122 may be formed at one end and the other end of the second plate 120. The injection port 121 may be an opening into which the sample may be injected. The injection port 121 may have an inner diameter larger than those of the pressure adjustment hole 300 of the sample suction button 200 and a haptic hole 511 of the haptic portion 500. The through-hole 122 may be an opening through which air may flow. The through-hole 122 opens the spacer 130, thereby guiding a flow of air toward the sample suction button 200. A center of the through-hole 122 may be vertically aligned with a center of the sample suction button 200 and a center of the haptic portion 500. The through-hole 122 may have an inner diameter larger than that of the injection port 121.

The second plate 120 may be made of a transparent material for observing the sample flowing on the first plate 110. A guide line 123 may be formed on an upper surface of the second plate 120. The guide line 123 may be an indicator informing of a minimum sample moving distance at which the sample may be analyzed, that is, a minimum injection amount of the sample. The guide line 123 may be provided in a groove shape or a protrusion shape.

The spacer 130 may provide the flow channel 131 guiding a movement of the sample when the sample is injected through the injection port 121. The flow channel 131 communicates between the injection port 121 and the through-hole 122, thereby providing a flow path through which the sample may flow. The flow channel 131 may be formed to extend continuously along a longitudinal direction of the spacer 130. The flow channel 131 may include first to seventh channel parts 131-1 to 131-7 having different widths from each other. The first channel part 131-1 may be vertically aligned with the injection port 121 of the second plate 120. The first channel part 131-1 may have an inner diameter larger than that of the injection port 121. The first channel part 131-1 may be formed to extend continuously toward a second channel part 131-2. The second channel part 131-2 may have a width smaller than that of the first channel part 131-1. The second channel part 131-2 may be formed to extend continuously toward a third channel part 131-3. The third channel part 131-3 may have a width larger than that of the second channel part 131-2. The third channel part 131-3 may be formed to extend continuously toward a fourth channel part 131-4. The fourth channel part 131-4 may have a width smaller than that of the third channel part 131-3. The fourth channel part 131-4 may have the same width as the second channel part 131-2. The fourth channel part 131-4 may be formed to extend continuously toward a fifth channel part 131-5. The fifth channel part 131-5 may have a width larger than that of the fourth channel part 131-4. The fifth channel part 131-5 may have the same width as the third channel part 131-3. The fifth channel part 131-5 may be formed to extend continuously toward a sixth channel part 131-6. The sixth channel part 131-6 may have a width smaller than that of the fifth channel part 131-5. The sixth channel part 131-6 may have the same width as the second channel part 131-2. The sixth channel part 131-6 may be formed to extend continuously toward a seventh channel part 131-7. The seventh channel part 131-7 may be vertically aligned with the through-hole 122 of the second plate 120. The seventh channel part 131-7 may have an inner diameter equal to or larger than that of the through-hole 122.

The spacer 130 may be disposed between the first plate 110 and the second plate 120. The spacer 130 may bond the first plate 110 and the second plate 120. An adhesive layer to which an adhesive is applied may be formed on both sides (an upper surface and a lower surface) of the spacer 130. For example, the spacer 130 may be a double-sided tape having an adhesive layer formed on the upper surface and the lower surface thereof. The adhesive layer may adhere and fix the lower surface of the spacer 130 and the upper surface of the first plate 110, and may adhere and fix the upper surface of the spacer 130 and the lower surface of the second plate 120. A shape of the spacer 130 may correspond to shapes of the first plate 110 and the second plate 120, and an area of the spacer 130 may be equal to or smaller than areas of the first plate 110 and the second plate 120. The spacer 130 may have a thickness of 20 to 1000 micrometers.

The sample suction button 200 may selectively provide a sample suction pressure for moving the sample to the flow channel 131. For example, when the pressurization on the sample suction button 200 is released, the sample suction button 200 may provide the sample suction pressure for moving the sample to the flow channel 131. The sample suction button 200 may be compressed by an external force when pressurized by the external force, and may return to an initial shape when the pressurization is released. For example, the sample suction button 200 may be made of an elastic rubber material capable of expanding and contracting by pressurization. The center of the sample suction button 200 may be vertically aligned with the center of the through-hole 122. The sample suction button 200 may include a button body 210, a button wing 220, a button step 230, and an air accommodating portion 240.

The button body 210 may be provided in a button shape made of an elastic material. The pressure adjustment hole 300 allowing air to enter and exit may be formed in the button body 210.

The button wing 220 may be formed to extend outward at an edge of the button body 210. For example, the button wing 220 may have a ring shape corresponding to the fixing ring 400. A lower surface of the button wing 220 may be supported on the upper surface of the second plate 120 through the fixing ring 400. An upper surface of the fixing ring 400 may be adhered and fixed to the lower surface of the button wing 220.

The button step 230 may be formed to extend downward from a lower portion of the button body 210. An inner diameter surface of the button step 230 may be formed to extend downward while being inclined outward. When the sample suction button 200 is pressurized by an external force, the inner diameter surface of the button step 230 may contact an upper surface of the haptic portion 500. An outer surface of the button step 230 may be formed to extend vertically downward.

The air accommodating portion 240 may provide a dome-shaped space for accommodating air introduced through the pressure adjustment hole 300. The air accommodating portion 240 may be formed at the lower portion of the button body 210. When the sample suction button 200 is pressurized by a user, the air accommodated in the air accommodating portion 240 may move through the flow channel 131, and when the pressurization by the user is released, the air in the flow channel 131 may move back to the air accommodating portion 240. In other words, when the air in the flow channel 131 moves back to the air accommodating portion 240, the sample suction pressure may be provided to the flow channel 131.

The pressure adjustment hole 300 may communicate between outside air and the air accommodating portion 240. The pressure adjustment hole 300 may be formed to penetrate through a central portion of the sample suction button 200. The pressure adjustment hole 300 may communicate with the haptic hole 511 of the haptic portion 500 and the through-hole 122 of the second plate 120. The pressure adjustment hole 300 may be vertically aligned with the haptic hole 511 and the through-hole 122. An inner diameter of the pressure adjustment hole 300 may be smaller than the inner diameter of the injection port 121.

The pressure adjustment hole 300 may control the air pressure in the flow channel 131 to be in equilibrium with the atmospheric pressure when the pressurization by the user is released. In other words, when the sample suction button 200 is pressurized by the user, the pressure adjustment hole 300 may be blocked by the user, and when the pressurization of the sample suction button 200 by the user is released, the pressure adjustment hole 300 may be opened.

The fixing ring 400 may fix an edge of the sample suction button 200 to the upper surface of the second plate 120. An adhesive layer may be applied to an upper surface and a lower surface of the fixing ring 400. The upper surface of the fixing ring 400 may be adhered and fixed to the edge of the sample suction button 200, and the lower surface of the fixing ring 400 may be adhered and fixed to the upper surface of the second plate 120. The fixing ring 400 may be provided in a ring shape. For example, the fixing ring 400 may be a double-sided tape having an adhesive layer formed on the upper surface and the lower surface thereof.

The haptic portion 500 may provide the user with a tactile sense of the sample suction button 200 being pressed when the sample suction button 200 is pressurized by the user. The haptic portion 500 may be made of a metal material for supporting the sample suction button 200 when the sample suction button 200 is pressurized by the user. The haptic portion 500 may include a haptic support 510 and a haptic leg 520.

The haptic support 510 may support the sample suction button 200 when the sample suction button 200 is pressurized by an external force. The haptic hole 511 may be formed at a center of the haptic support 510. The haptic hole 511 may communicate with the pressure adjustment hole 300 of the sample suction button 200, the through-hole 122, the injection port 121, and the flow channel 131. Air may enter and exit the haptic hole 511 when the sample suction button 200 is pressurized by an external force or the pressurization is released. An inner diameter of the haptic hole 511 may be equal to or larger than the inner diameter of the pressure adjustment hole 300, and may be smaller than the inner diameter of the injection port 121.

The haptic leg 520 may be provided in a plurality extending from an edge of the haptic support 510. Ends of the plurality of haptic legs 520 may be supported on the upper surface of the first plate 110. When the sample suction button 200 is pressurized by an external force, the plurality of haptic legs 520 elastically support the haptic support 510 on the upper surface of the first plate 110, thereby returning the haptic support 510 to an initial position when the pressurization by the external force is released.

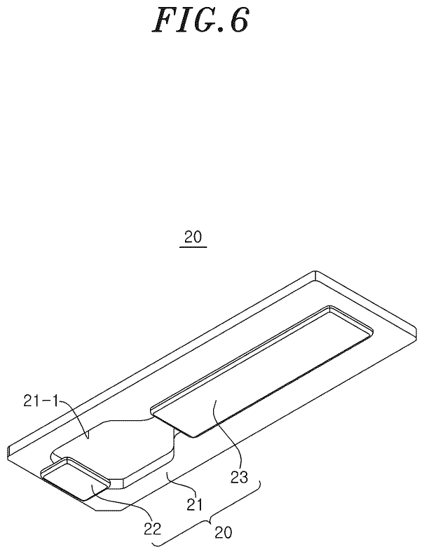

Meanwhile, referring to FIG. 6, the holder 20 may prevent contamination by a residual sample of the sample aspirator 10. The holder 20 may mount the sample aspirator 10 on an optical device. For example, the holder 20 may be provided in a form of a 75×25 mm cover glass universally mountable on a microscope. The holder 20 may include a holder body 21, a first holder support 22, and a second holder support 23.

The holder body 21 may provide a mounting groove 21-1 into which the sample aspirator 10 is insertable. The mounting groove 21-1 may have a shape corresponding to the edge of the sample aspirator 10. A height of the mounting groove 21-1 may be equal to or shorter than a height of the sample aspirator 10.

The first holder support 22 may be formed at a lower side of one end of the holder body 21 to support one end of the sample aspirator 10. The first holder support 22 may be formed to protrude from the lower side of the one end of the holder body 21 toward the other end. The first holder support 22 may cover at least a portion of a lower portion of one end side of the mounting groove 21-1.

The second holder support 23 may support the other end of the sample aspirator 10. The second holder support 23 may be formed at a lower side of the other end of the holder body 21. The second holder support 23 may be formed to protrude from the lower side of the other end of the holder body 21 toward the one end. The second holder support 23 may cover at least a portion of a lower portion of the other end side of the mounting groove 21-1.

Hereinafter, actions and effects of the sample examining apparatus according to the present disclosure will be described.

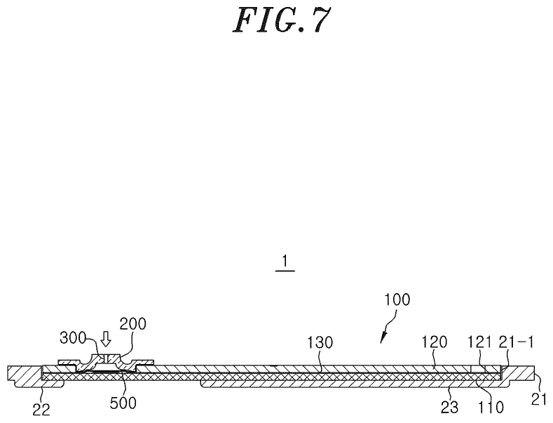

Referring to FIG. 7, in order to inject the sample into the sample aspirator, first, the user pushes and pressurizes the sample suction button in a state where the pressure adjustment hole is blocked. When the sample suction button is pressurized, the haptic portion may provide the user with a tactile sense of the sample suction button being pressed.

When the sample contacts the injection port of the second plate in a state where the sample suction button is pressurized with the pressure adjustment hole blocked, preparation for injecting the sample into the sample aspirator is completed. When the user releases the pressurization as much as a restoring range of the haptic portion and an elasticity of the sample suction button allow, a suction pressure is provided to the flow channel as much as an internal volume of the sample suction button changes, so that the sample may flow from the injection port to the through-hole side. Thereafter, when the pressure adjustment hole is opened again to equalize a pressure at the through-hole side and a pressure at the injection port side, that is, when the air pressure in the flow channel is in equilibrium with the atmospheric pressure, the sample may be continuously maintained in a stationary state within the flow channel. When the stationary state of the sample within the flow channel is continuously maintained, precise observation of the sample is possible.

Meanwhile, when a pressure adjustment hole is not perforated in the sample suction button, the flow channel becomes a closed system, so that even after the sample is injected through the injection port, an unnecessary flow may occur in the sample due to a minute elastic force of the sample suction button even when the user slightly touches the sample suction button. Furthermore, the sample may continuously move from the injection port side to the through-hole side due to absence of an external force to offset capillary phenomenon and surface tension. Therefore, even after the injection of the sample through the injection port is completed, the sample may continuously flow in the flow channel, and as a result, precise observation of the sample may be difficult.

As described above, the present disclosure provides a disposable chamber having a fixed height for quantitative and qualitative analysis of particles present in a minute amount of sample, thereby enabling an exact concentration calculation of the particles in the sample.

Furthermore, according to the present disclosure, staining is performed simultaneously with the injection of the sample, achieving staining simply by injecting the sample even without separately staining the sample from the outside.

Furthermore, according to the present disclosure, when particles present in a minute amount of sample are injected into the flow channel, the particles are uniformly distributed without occurrence of distortion in flow or concentration of the sample.

Furthermore, the present disclosure minimizes deviation among individuals performing the injection when injecting a minute amount of sample, thereby allowing the particles present in the minute amount of sample to be more accurately measured.

The examples of the present disclosure have been described above as specific embodiments, but these are only examples, and the present disclosure is not limited thereto, and should be construed as having the widest scope according to the technical spirit disclosed in the present specification. A person skilled in the art may combine/substitute the disclosed embodiments to implement a pattern of a shape that is not disclosed, but it also does not depart from the scope of the present disclosure. In addition, those skilled in the art can easily change or modify the disclosed embodiments based on the present specification, and it is clear that such changes or modifications also belong to the scope of the present disclosure.

What is claimed is:

1. A sample aspirator comprising:
a main body including a flow channel to allow a sample to flow;
a sample suction button configured to be compressed in response to being pressed by a user and to return to an initial shape in response to the pressing being released; and
a pressure adjustment hole configured to equalize an air pressure in the flow channel with an atmospheric pressure when the pressing is released,
wherein the sample suction button is configured to provide, to the flow channel, a sample suction pressure for moving the sample in response to the pressing being released.

2. The sample aspirator of claim 1, wherein the main body comprises:
a first plate;
a second plate;
an injection port through which the sample is injected into the flow channel; and
a spacer disposed between the first plate and the second plate and providing the flow channel.

3. The sample aspirator of claim 1, wherein the sample suction button includes an air accommodating portion configured to be in communication with the flow channel and to accommodate air introduced through the pressure adjustment hole.

4. The sample aspirator of claim 1, further comprising:
a haptic portion configured to provide the user with a tactile sense of the sample suction button being pressed in response to the sample suction button being pressed by the user.

5. The sample aspirator of claim 2, wherein the spacer has a thickness of 20 to 1000 micrometers.

6. The sample aspirator of claim 2, wherein adhesive is configured to be applied to both surfaces of the spacer so that the spacer is bonded to the first plate and the second plate.

7. The sample aspirator of claim 2, wherein a staining solution is configured to be applied to a portion of the flow channel formed by the first plate and the second plate to allow particles in the sample to be identified.

8. The sample aspirator of claim 4, wherein the haptic portion comprises:
a haptic support configured to support the sample suction button in response to the sample suction button being pressed by the user; and
a plurality of haptic legs extending from an edge of the haptic support and having end portions supported on the main body.

9. The sample aspirator of claim 8, wherein a haptic hole communicating with the pressure adjustment hole and the flow channel is formed at a center of the haptic support.

10. A sample examining apparatus comprising:
a sample aspirator; and
a holder configured to receive the sample aspirator to prevent contamination by a residual sample of the sample aspirator,
wherein the sample aspirator includes:
a main body including a flow channel to allow a sample to flow;
a sample suction button configured to be compressed in response to being pressed by a user and to return to an initial shape when the pressing is released; and
a pressure adjustment hole configured to equalize an air pressure in the flow channel with an atmospheric pressure in response to the pressing being released,
wherein the sample suction button is configured to provide, to the flow channel, a sample suction pressure for moving the sample in response to the pressing being released.

11. The sample examining apparatus of claim 10, wherein the holder is configured to be mounted to an optical device.
